(19) United States
(12) Patent Application Publication
(10) Pub. No.: US 2019/0061139 A1
(43) Pub. Date: Feb. 28, 2019

(54) WRENCH HOLDER ASSEMBLY

(71) Applicant: Jui Chien Kao, TAICHUNG (TW)

(72) Inventor: Jui Chien Kao, TAICHUNG (TW)

(21) Appl. No.: 15/690,185

(22) Filed: Aug. 29, 2017

(51) Int. Cl. B25H 3/04; B25H 3/06; B65D 85/20

(52) U.S. Cl. CPC B25H 3/04; A47F 7/00; B65D 85/20; B25H 3/06

(57) ABSTRACT

A wrench holder assembly has a body and a positioning base. The body has a top surface, two side edges, and two side walls. The two side walls are formed on and protrude from the two side edges respectively. Each side wall has multiple engaging recesses defined in the side wall. Each engaging recess in one of the side walls corresponds to a respective one of the engaging recesses in the other one of the side walls in position. The positioning base is mounted on the top surface of the body, is located between the side walls, and has a track base and multiple positioning elements. The positioning elements are moveably mounted on the track base and are capable of being positioned relative to the track base.

### BACKGROUND OF THE INVENTION

### 1. Field of the Invention

The present invention relates to a tool holder, and more particularly to a wrench holder assembly.

### 2. Description of Related Art

A conventional tool holder for holding wrenches substantially comprises a body and two side walls formed on two side edges of the body. Each side wall has multiple engaging recesses defined in the side wall. Accordingly, a wrench can be held in corresponding engaging recesses in the two side walls to hold the wrench on the body in position.

However, the conventional tool holder does not have any additional holding structure for holding the wrench, and the wrench is only held in two corresponding engaging recesses in the side walls. Therefore, the conventional tool holder cannot provide a secure holding effect to the wrenches, and the wrenches are easily shaken and even easily detached from the tool holder.

To overcome the shortcomings, the present invention tends to provide a wrench holder assembly to mitigate or obviate the aforementioned problems.

### SUMMARY OF THE INVENTION

The main objective of the invention is to provide a wrench holder assembly that can securely hold wrenches in position.

The wrench holder assembly has a body and a positioning base. The body has a top surface, two side edges, and two side walls. The two side walls are formed on and protrude from the two side edges respectively. Each side wall has multiple engaging recesses defined in the side wall. Each engaging recess in one of the side walls corresponds to a respective one of the engaging recesses in the other one of the side walls in position. The positioning base is mounted on the top surface of the body, is located between the side walls, and has a track base and multiple positioning elements. The positioning elements are moveably mounted on the track base and are capable of being positioned relative to the track base.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a wrench holder assembly in accordance with the present invention,

FIG. 2 is an exploded perspective view of the wrench holder assembly in FIG. 1,

FIG. 3 is an operational perspective view of the wrench holder assembly in FIG. 1,

FIG. 4 is a side view in partial section of the wrench holder assembly in FIG. 1,

FIG. 5 is an enlarged operational cross sectional side view of the wrench holder assembly in FIG. 1; and

FIG. 6 is another enlarged operational cross sectional side view of the wrench holder in FIG. 1.

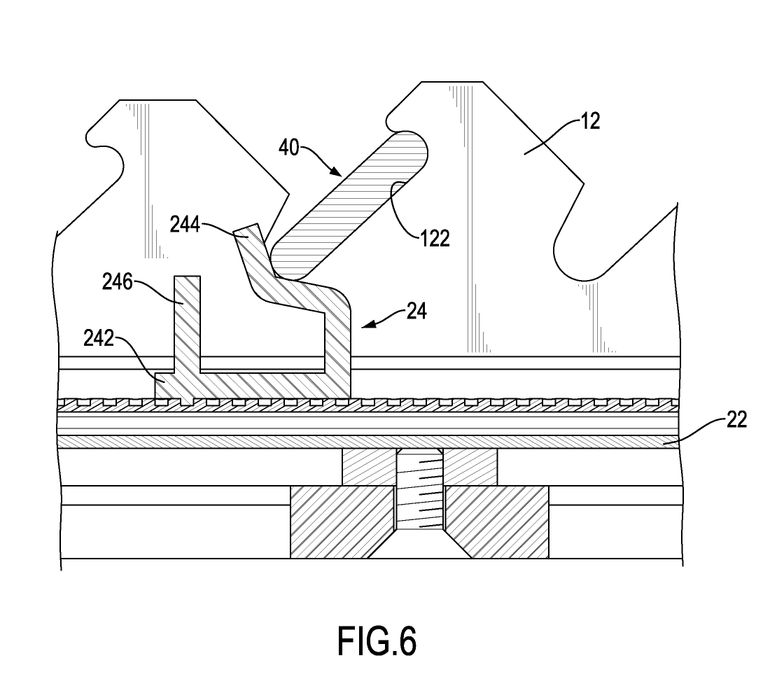

### DETAILED DESCRIPTION OF PREFERRED EMBODIMENT

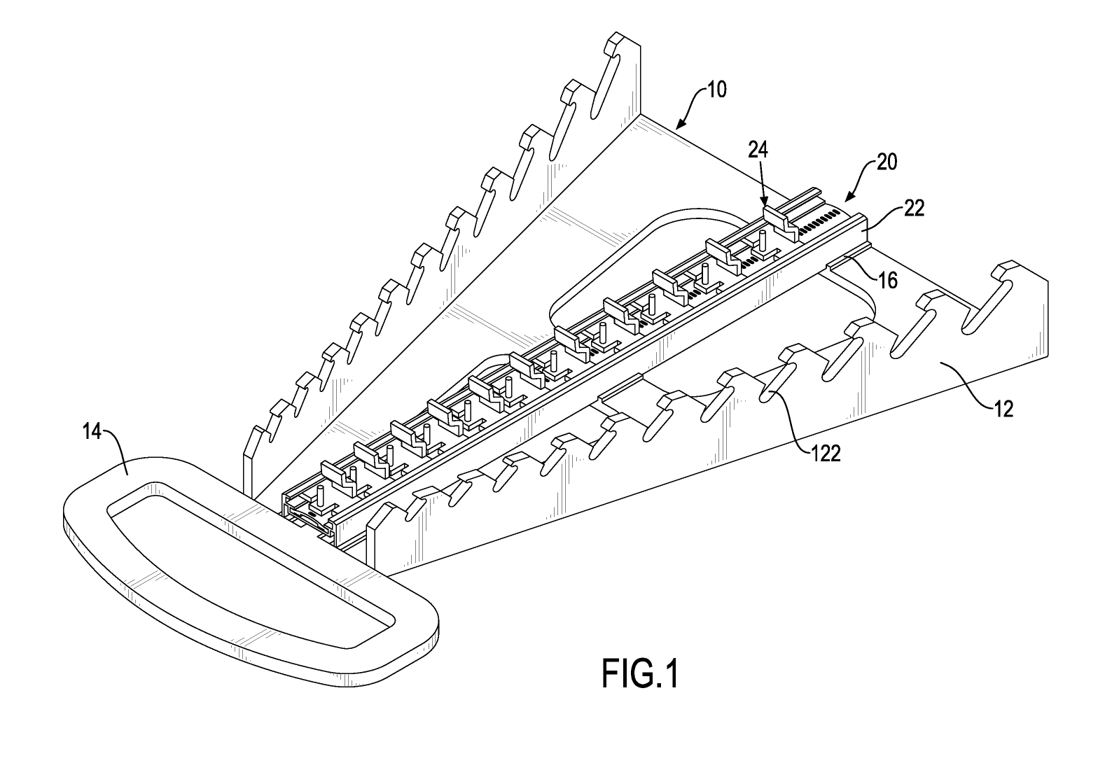

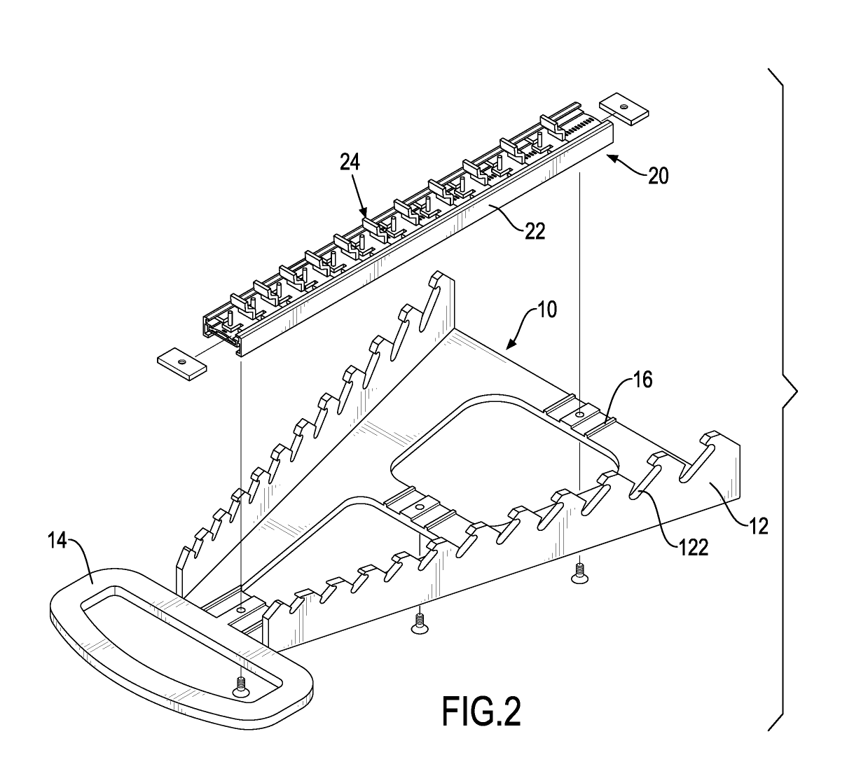

With reference to FIGS. 1 to 3, a wrench holder assembly in accordance with the present invention comprises a body 10 and a positioning base 20.

The body 10 may be a trapezoidal board and has a top surface, two side edges, and two side walls 12. The side walls 12 are formed on and protrude from the two side edges respectively, and each side wall 12 has multiple engaging recesses 122 defined in the side wall 12. Each engaging recess 122 in one of the side walls 12 corresponds to a respective one of the engaging recesses 122 in the other one of the side walls 12 in position. In addition, the body 10 further has a handle 14 formed on an end of the body 10.

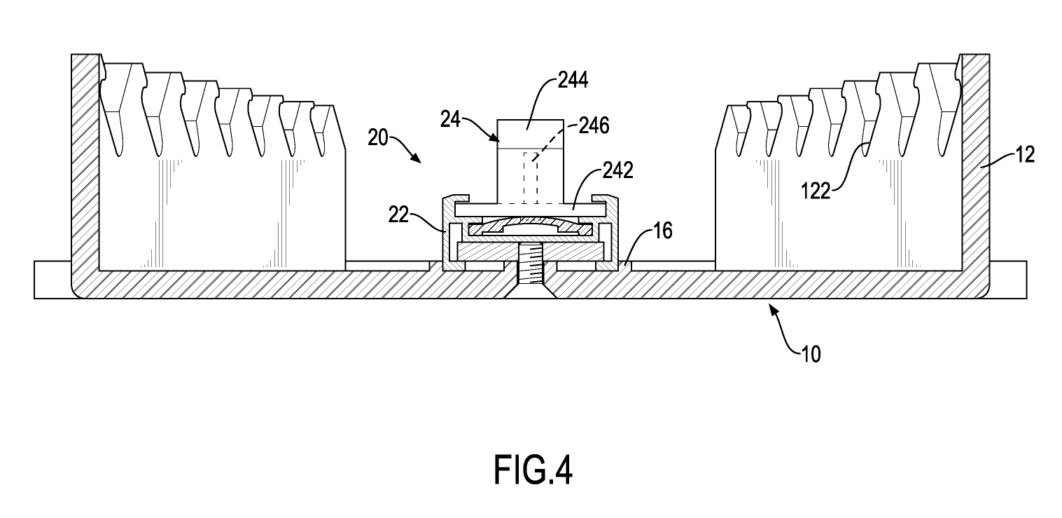

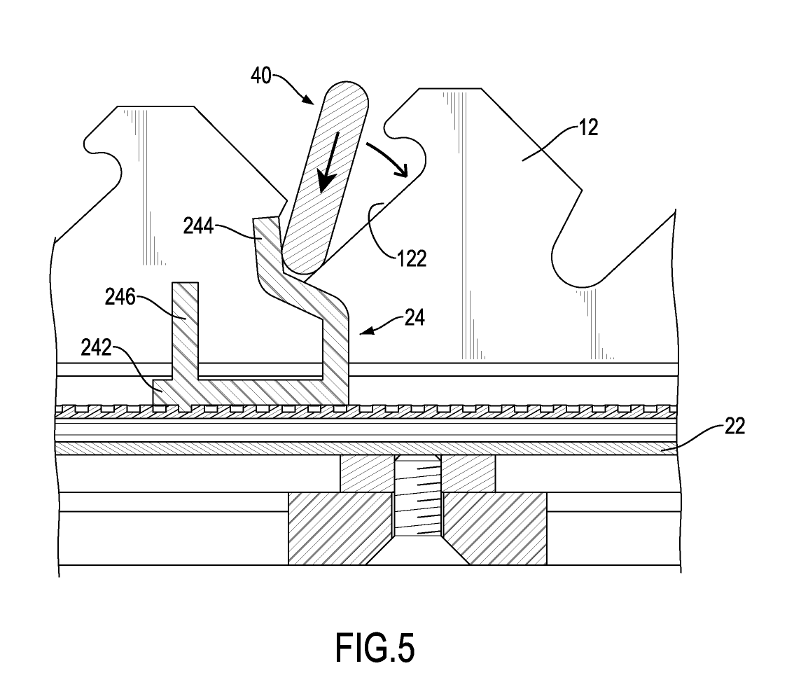

With further reference to FIGS. 4 and 5, the positioning base 20 is mounted on the top surface of the body 10, is located between the side walls 12, and comprises a track base 22 and multiple positioning elements 24. The track base 22 is mounted securely on the top surface of the body 10 by fasteners, such as bolts. In addition, the body 10 may further have two positioning ribs 16 formed on and protruding from the top surface of the body 10 and abutting respectively on two sides of the track base 22 to hold the track base 22 in position.

The multiple positioning elements 24 are moveably mounted on the track base 22 and are capable of being positioned relative to the track base 22. The amount of the positioning elements 24 corresponds to an amount of the engaging recesses 122 in each side wall 12. Each positioning element 24 comprises a bottom board 242, a positioning board 244, and a pushing arm 246. The bottom board 242 is mounted moveably on the track base 22. The positioning board 244 is curved and is formed on and protrudes from an end of the bottom board 242. In addition, the track base 22 has multiple first engaging portions formed on a top surface of the track base 22. The bottom board 242 of each positioning element 24 has a second engaging portion formed on a bottom of the bottom board 242 and engaged with one of the first engaging portions on the track base 22. With the engagement between the second engaging portion and a corresponding one of the first engaging portions, the positioning element 24 can be securely held on the track base 22 in position. The pushing arm 246 is formed on and protrudes from the bottom board 242 of the positioning element 24.

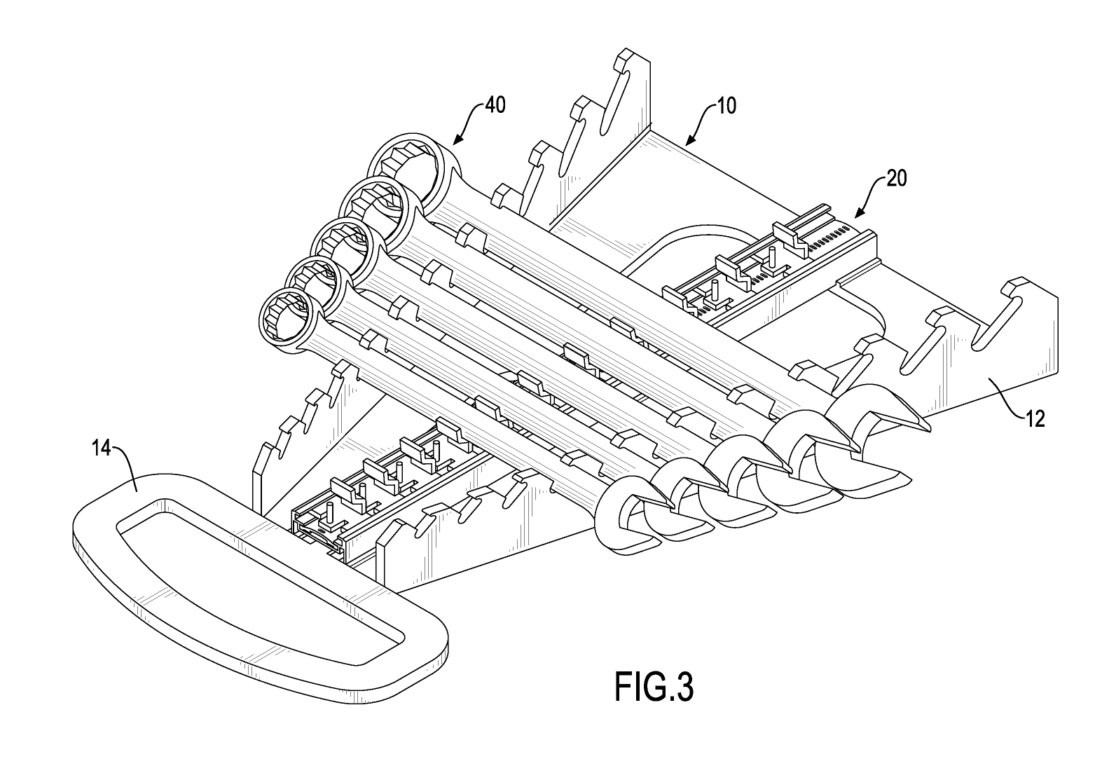

With reference to FIGS. 3 to 5, when in use, because the body 10 is trapezoidal in shape, the side walls 12 extend away from each other. Consequently, multiple wrenches 40 in different sizes can be held respectively in corresponding engaging recesses 122 in the side walls 12. The positioning boards 244 of the positioning elements 24 can abut respectively on middles of the wrenches 40. Accordingly, the positioning elements 24 can provide a positioning effect to the wrenches 40, such that the wrenches 40 can be securely held on the body 10 and can be kept from being shaken or detached from the body 10.

Because the positioning elements 24 are moveably mounted on and positioned relative to the track base 22, the positions of the positioning elements 24 can be adjusted to fit with the wrenches 40 in different sizes. Therefore, the wrench holder assembly in accordance with the present invention is versatile in use. In addition, to move the positioning element 24 relative to the track base 22, the pushing arm 246 can be pushed firstly to disengage the second engaging portion from the corresponding first engaging portion. Thus, the positioning element 24 can be smoothly moved to a desired position, so the adjustment of the positions of the positioning elements 24 is convenient.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A wrench holder assembly comprising:
a body having
a top surface;
two side edges; and
two side walls formed on and protruding from the two side edges respectively, and each side wall having multiple engaging recesses defined in the side wall, wherein each engaging recess in one of the side walls corresponds to a respective one of the engaging recesses in the other one of the side walls in position; and
a positioning base mounted on the top surface of the body, located between the side walls, and comprising
a track base; and
multiple positioning elements moveably mounted on the track base and capable of being positioned relative to the track base.

2. The wrench holder assembly as claimed in claim 1, wherein the body is a trapezoidal board.

3. The wrench holder assembly as claimed in claim 2, wherein an amount of the positioning elements of the positioning base corresponds to an amount of the engaging recesses in each side wall.

4. The wrench holder assembly as claimed in claim 3, wherein
each positioning element comprises
a bottom board mounted moveably on the track base; and
a curved positioning board formed on and protruding from an end of the bottom board;
the track base has multiple first engaging portions formed on a top surface of the track base; and
the bottom board of each positioning element has a second engaging portion formed on a bottom of the bottom board and engaged with one of the first engaging portions on the track base.

5. The wrench holder assembly as claimed in claim 4, wherein each positioning element further comprises a pushing arm formed on and protruding from the bottom board of the positioning element.

6. The wrench holder assembly as claimed in claim 5, wherein the body further comprises a handle formed on an end of the body.

7. The wrench holder assembly as claimed in claim 6, wherein the body further has two positioning ribs formed on and protruding from the top surface of the body and abutting respectively on two sides of the track base to hold the track base in position.

8. The wrench holder assembly as claimed in claim 1, wherein an amount of the positioning elements of the positioning base corresponds to an amount of the engaging recesses in each side wall.

9. The wrench holder assembly as claimed in claim 8, wherein
each positioning element comprises
a bottom board mounted moveably on the track base; and
a curved positioning board formed on and protruding from an end of the bottom board;
the track base has multiple first engaging portions formed on a top surface of the track base; and
the bottom board of each positioning element has a second engaging portion formed on a bottom of the bottom board and engaged with one of the first engaging portions on the track base.

10. The wrench holder assembly as claimed in claim 9, wherein each positioning element further comprises a pushing arm formed on and protruding from the bottom board of the positioning element.

11. The wrench holder assembly as claimed in claim 10, wherein the body further comprises a handle formed on an end of the body.

12. The wrench holder assembly as claimed in claim 11, wherein the body further has two positioning ribs formed on and protruding from the top surface of the body and abutting respectively on two sides of the track base to hold the track base in position.

13. The wrench holder assembly as claimed in claim 1, wherein
each positioning element comprises
a bottom board mounted moveably on the track base; and
a curved positioning board formed on and protruding from an end of the bottom board;
the track base has multiple first engaging portions formed on a top surface of the track base; and
the bottom board of each positioning element has a second engaging portion formed on a bottom of the bottom board and engaged with one of the first engaging portions on the track base.

14. The wrench holder assembly as claimed in claim 13, wherein each positioning element further comprises a pushing arm formed on and protruding from the bottom board of the positioning element.

15. The wrench holder assembly as claimed in claim 14, wherein the body further comprises a handle formed on an end of the body.

16. The wrench holder assembly as claimed in claim 15, wherein the body further has two positioning ribs formed on and protruding from the top surface of the body and abutting respectively on two sides of the track base to hold the track base in position.

17. The wrench holder assembly as claimed in claim 1, wherein the body further comprises a handle formed on an end of the body.

18. The wrench holder assembly as claimed in claim 1, wherein the body further has two positioning ribs formed on and protruding from the top surface of the body and abutting respectively on two sides of the track base to hold the track base in position.
